(19) United States
(12) Patent Application Publication
(10) Pub. No.: US 2018/0007168 A1
(43) Pub. Date: Jan. 4, 2018

(54) SERVER-SPECIFIED END-OF-LIST ACTIONS

(71) Applicant: GOOGLE INC., Mountain View, CA (US)

(72) Inventors: Naoki Iwasaki, Tokyo (JP); Satoshi Niwa, Tokyo (JP); Takahiro Kosakai, Tokyo (JP); David Robert Gordon, Tokyo (JP)

(21) Appl. No.: 14/327,148

(22) Filed: Jul. 9, 2014

Related U.S. Application Data
(60) Provisional application No. 61/844,297, filed on Jul. 9, 2013.

(51) Int. Cl. H04L 29/06

(52) U.S. Cl. CPC H04L 67/42

(57) ABSTRACT

A method includes generating a description of a specific geographic context, and providing the description of the specific geographic context to a network server. The method also includes receiving, from the network server: (i) an ordered list of items, each including respective geographic data related to the specific geographic context, and (ii) an indication of an action to be executed at the client device when a user accesses an end of the list of items via the user interface. The list of items is presented to a user via a user interface, and, in response to an indication that the end of the list of items is reached by the user, the indicated action is executed.

### CROSS-REFERENCE TO RELATED APPLICATIONS

This application claims priority to U.S. Provisional Patent Application No. 61/844,297, filed on Jul. 9, 2013, and titled “SERVER-SPECIFIED END-OF-LIST ACTIONS,” the entire disclosure of which is hereby expressly incorporated by reference herein.

### FIELD OF TECHNOLOGY

The present disclosure relates generally to displaying interactive digital content and, more particularly, to server specified actions associated with scrolling through digital content.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Many software applications receive digital content from network servers in the form of itemized lists. An individual item in such a list can include text, uniform resource locators (URLs), images, video, audio, etc. By scrolling through digital content (e.g., via a “fling” or “drag” gesture, trackball movement, or scrollbar interaction), a user can display all of the items in the currently supplied itemized list.

### SUMMARY

Generally speaking, a digital mapping application of this disclosure receives, from a content server, a list of interactive digital content, such as itemized text, image, URL, etc. content, for display within the mapping application. The mapping application also receives, from the content server, an indication of an action to be executed at the client device when the end of the list is reached (e.g., when a user scrolls to the end of the list). The mapping applications provides the list of interactive digital content via a user interface of a client device and in response to the end of the list being reached, automatically executes the indicated action.

In particular, one example method for providing geographic content via a user interface of the client device comprises generating, by one or more processors, a description of a specific geographic context, and providing, by the one or more processors, the description of the specific geographic context to a network server. The method further comprises receiving, from the network server: (i) an ordered list of items, each including respective geographic data related to the specific geographic context, and (ii) an indication of an action to be executed at the client device when a user accesses an end of the list of items via the user interface. Still further, the method comprises causing, by the one or more processors, the list of items to be presented to a user via the user interface of the client device, and, in response to an indication that the end of the list of items is reached by the user, executing, by the one or more processors the indicated action.

Another example method in a network server for generating and communicating server-specified actions to a client device comprises receiving a description of the specific geographic context, and, based on a specific geographic context corresponding to the client device, generating, by one or more processors, an ordered list of selectable items, each selectable item in the ordered list of selectable items including interactive digital content. The method further comprises selecting, by the one or more processors, an action to be executed on the client device when a user of the client device accesses an end of the ordered list of selectable items, and providing, by the one or more processors, the ordered list of selectable items and an indication of the action to the client device.

In yet another embodiment, a system comprises one or more processors and a non-transitory computer-readable medium storing thereon instructions. When executed by the one or more processors, the instructions cause the system to receive a description of the specific geographic context, and, based on a specific geographic context corresponding to the client device, generate an ordered list of selectable items, each selectable item in the ordered list of selectable items including interactive digital content. The instructions also cause the system to select an action to be executed on the client device when a user of the client device accesses an end of the ordered list of selectable items, and provide the ordered list of selectable items and an indication of the action to the client device.

### BRIEF DESCRIPTION OF THE DRAWINGS

FIG. 1 illustrates an example computing environment in which a mobile device can receive indication of and execute server-specified actions;

FIG. 2 illustrates an example structure of itemized lists and corresponding server-specified actions which can be received by the example mobile device illustrated in FIG. 1;

FIGS. 3 and 4 illustrate example scrollable digital content for which a network server of FIG. 1 can specify end-of-list actions;

FIG. 5 is a flow diagram of an example method for performing server-specified end-of-list action, which can be implemented by the example mobile device illustrated in FIG. 1; and

FIG. 6 is a flow diagram of an example method for generating itemized lists with corresponding server-specified end-of-list actions, which can be implemented by the example map data server illustrated in FIG. 1.

### DETAILED DESCRIPTION

A geographical content server supplies a client device with a list of interactive digital content, such as selectable (e.g., with a click or tap) text, images, URLs, etc. content, for display within a mapping application. The client device displays the content and allows the user to scroll through the supplied list (e.g., with a “fling” gesture on a touchscreen). When the user scrolls to the end of the list, the mobile device executes a server-specified action corresponding to the list of interactive digital content. For example, this action can be “request more data,” “show an advertisement,” “open browser,” etc. The server sends an indication of such an action along with the list of interactive digital content.

### System Overview

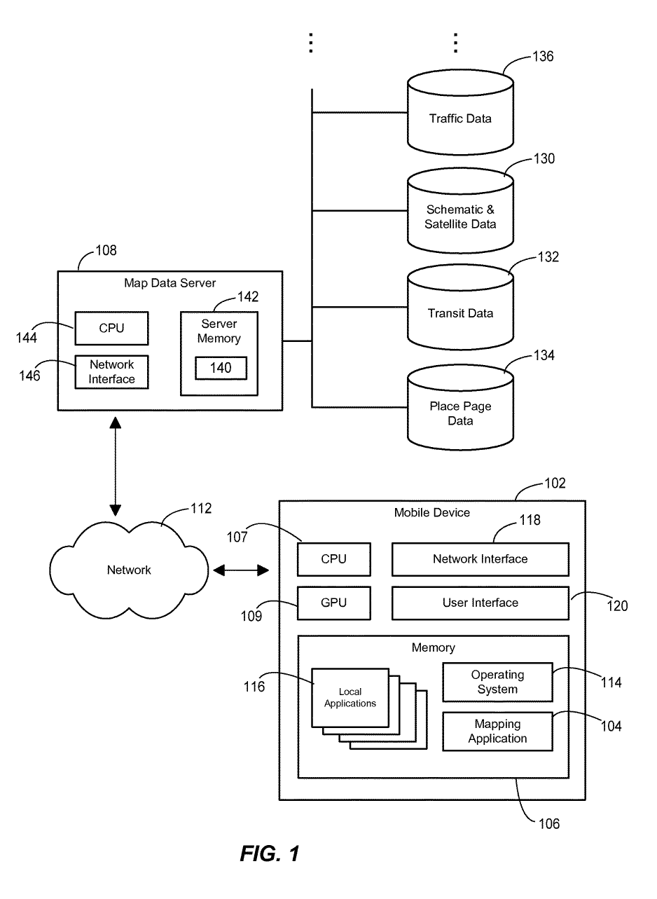

FIG. 1 illustrates an example computing environment 100 in which a mobile device 102 may execute server-specified actions while scrolling through itemized lists of digital content. The mobile device 102 may execute a mapping application 104 stored within a memory 106 via a CPU 107 and/or a graphic processing unit (GPU) 109, where digital content displayed by the mapping application 104 is supplied, in the form of itemized lists, by a map data server 108 via a network 112. For example, the mapping application 104 may be a special-purpose application available at an online application store disposed at the map data server 108 or an application server (not shown). A user of the client device 102 (or mobile device 102) may retrieve a copy of the mapping application 104 from the application server and “install” the retrieved copy of the mapping application on the client device 102. By way of example, the mobile device 102 may be a smartphone, tablet computer, laptop computer, etc.

The memory 106 may be tangible, non-transitory memory and may include any types of suitable memory modules, including random access memory (RAM), read only memory (ROM), flash memory, other types of persistent memory, etc. In addition to the mapping application 104, the memory 106 stores an operating system (OS) 114 and one or more local applications 116 or modules. The operating system 114 may be any type of suitable operating system for example, and the one or more local applications 116 may include a variety of installed applications, such as a web browser application. In some scenarios, some of the one or more local applications 116 and the mapping application 104 may receive digital content via a network interface 118 and may interact with a user of the mobile device 102 via a user interface 120. The user interface 120 may be a touchscreen, for example.

The map data server 108, from which the mobile device receives itemized lists of digital content, may be communicatively coupled to multiple databases such as, for example, (i) a schematic and satellite database 130 storing street and road information, topographic data, satellite imagery, etc., (ii) a transit database 132 storing information related to public transport routes, schedules, alerts, prices, etc., (iii) a place page data 134 storing information about businesses including addresses, hours of operations, customer reviews, etc., (iv) a traffic database 136 storing current traffic conditions, and other databases. In general, the map server 108 can receive information related to geographic locations from any number of suitable databases, web services, etc.

The schematic and satellite database 130 can store data in a raster format, a vector format, or both. Further, in some implementations, the data is organized into map tiles at multiple zoom levels to facilitate serving map data to client devices. Depending on the implementation, the map data server 108 can provide map and directions data to client devices separately or together in map tiles, for example.

In an implementation, the map data server 108 includes a list generator routine 140 stored in a server memory 142 and executed by a server CPU 144. The list generator routine 140 may generate itemized lists of digital content from the content stored in databases 130-136, and the map data server 108 may send the lists of digital content to mobile devices, such as mobile device 102, via the network interface 112. In some implementations, the list generator routine 140 may generate itemized lists that include an action to be taken by a mobile device upon scrolling to the end of the list of digital content.

### Use of Server-Specified Actions

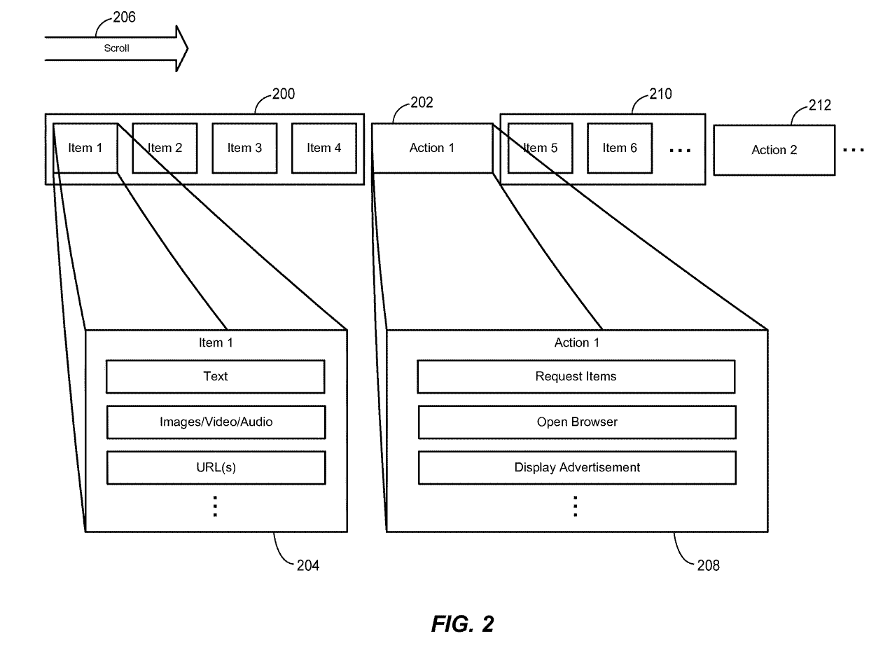

FIG. 2 illustrates an example structure of itemized lists of digital content with one or more server-specified actions. In an example scenario, the list generator routine 140 on the map data server 108 generates and sends a list 200 of digital content to the mobile device 102. The list 200 of digital content may include four items (e.g., the digital content in the list 200 may be itemized and/or ordered as “Item 1”-“Item 4”) made up of various types of digital content. By way of example, “Item 1” may include text content, image/video/audio content, URL content, etc., as illustrated in expanded item view 204. In general, however, a list of content may include any number of items, and each item may include any suitable types of digital content.

Each of the items (“Item 1”-“Item 4”) in the list 200 may include selectable, or otherwise interactive, elements. For example, when displayed on a mobile device, one or more URLs in “Item 1” may be selectable (e.g., may be selected with a tap on a touchscreen) such that a web browser application on the mobile device opens the web page locations specified by the URLs. In another example, when displayed on a mobile device, one or more video or audio elements of “Item 1” may be selectable by a user of a mobile device so as to “play” respective video or audio content.

Further the items in the list 200 may be ordered, as “Item 1”-“Item 4,” so as to promote or emphasize certain content and to facilitate the detection of a user reaching the end of the list 200. For example, the map data server 108 may order the “Item 1”-“Item 4” based on a measure of relevance to a geographic context (e.g., geographic query) received from the mobile device 102. In addition, the mobile device 102 may exploit the ordering of the list 200 to detect a user reaching the end of the list 200 (e.g., by associating a display of “Item 4” with the end of the list 200).

Along with the list 200, the list generator routine 140 may generate and send an action 202 (“Action 1”) to the mobile device 102. The action 202 indicates which action is to be taken upon scrolling to the end of the list 200. Scrolling may include transitioning from a display of

“Item 1” to a display of “Item 4,” as indicated by the arrow 206. For example, a user may use a vertical or horizontal “fling” gesture on a touchscreen to move from the display of text content associated with “Item 1” to text content associated with “Item 4.” When a user scrolls to the end of the list 200 of digital content, the server-specified action 202 instructs the mobile device 102 what action to take.

The action 202 may instruct the mobile device to request new or different items, open a browser application, display an advertisement, etc., as illustrated in an expanded action view 208. In some implementations, each action corresponding to a list of content instructs a mobile device to perform only one task (e.g., display advertisement). In other implementations, an action may instruct a mobile device to perform any suitable number of tasks including tasks both visible and invisible to the user of the mobile device.

If the action 202 includes an instruction to request new items, the mobile device 102 may request new items from the map data server 108, and the map data server 108 may send a new list 210 of digital content to the mobile device 102. In addition, the map data server 108 may send a new action 212 along with the new itemized list 210 instructing the mobile device 102 to perform one or more tasks upon scrolling to the end of the list 210. In this way, the map data server 108 may trigger unique actions for each list of digital content corresponding to scrolling operations through the lists of digital content, in an implementation.

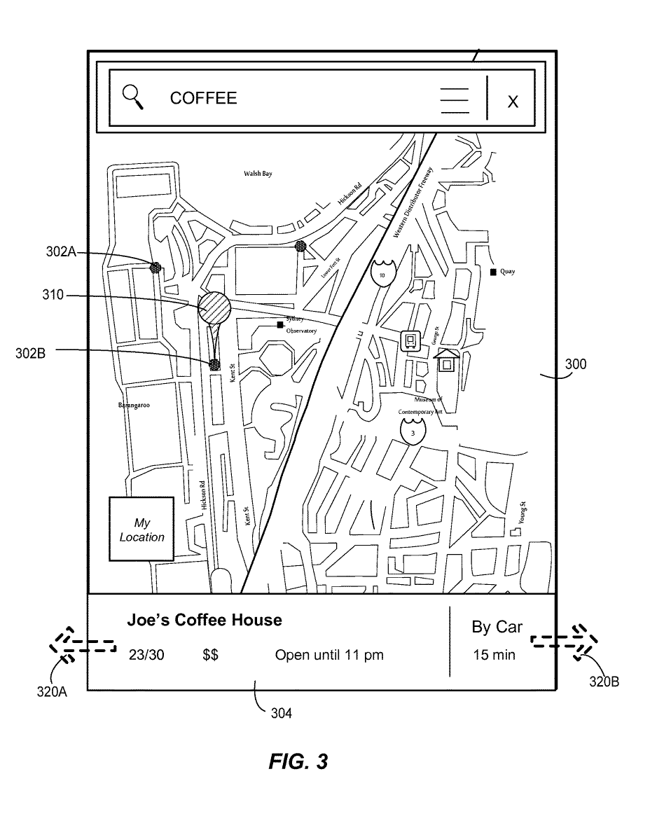

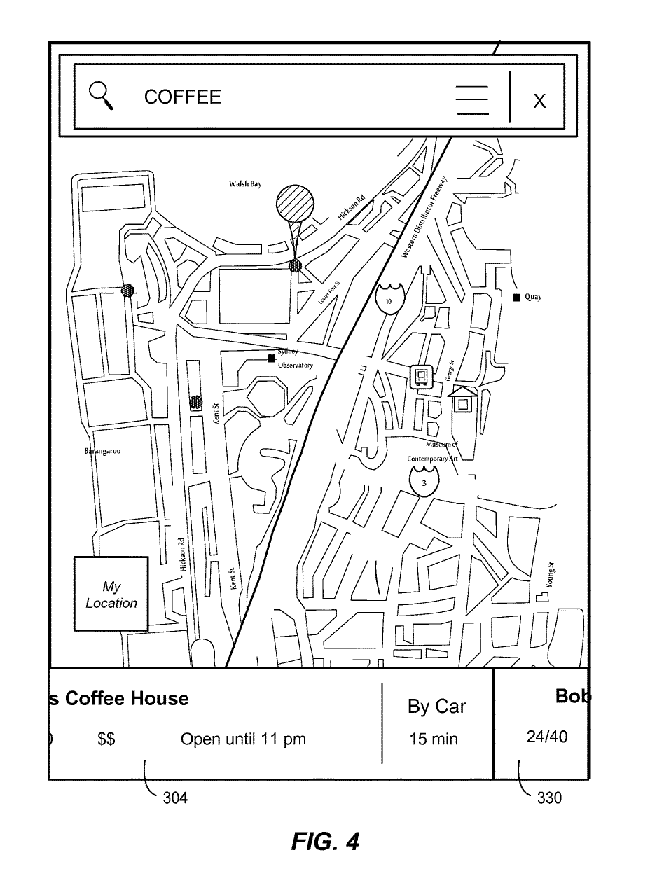

FIGS. 3 and 4 are example screenshots of a mapping application in which scrolling triggers a server-specified action. More specifically, FIG. 3 illustrates an example screenshot of a mapping application displaying a digital map 300 of an area along with search results. For each search result, the mapping application provides an indicator 302 overlaying the digital map at a respective location, as well as an informational card 304, which corresponds to the currently selected search result (indicated on the digital map 300 using a location marker 310). The informational card 304 can include text, images, lines, shapes, etc.

A server (such as the map data server 108) supplies the location of the indicator 302 and the data for generating the informational card 304 as one of the items in a list, according to an example scenario. Each item thus can include the location of a search result, the phone number, the review data, etc. The user can scroll through the list in one of the two directions indicated by arrows 320. To this end, the user can apply a touchscreen gesture, such as a fling or swipe. That is, a user may move one or more fingers across the surface of a touchscreen in a pre-defined pattern so as to trigger scrolling through the list. Generally, the user may utilize any suitable touchscreen gesture(s) or other interaction(s) with the mobile device, such as pushing a button, applying pressure to a portion of a device, moving body parts in a detectable (e.g., by the mobile device) manner, etc., to trigger scrolling or navigation through a list. For further clarity, FIG. 4 illustrates the transition between two informational cards, 304 and 330, that correspond to adjacent items on the list.

Upon scrolling to the end of the list, the mobile device in this example executes the action supplied by a map data server along with the list, in an implementation. For example, an action can instruct the mapping application to go back to the beginning of the list. As another example, the action can instruct the mapping application to request additional search results from the server. Other examples can include displaying an advertisement, launching a web browser, etc.

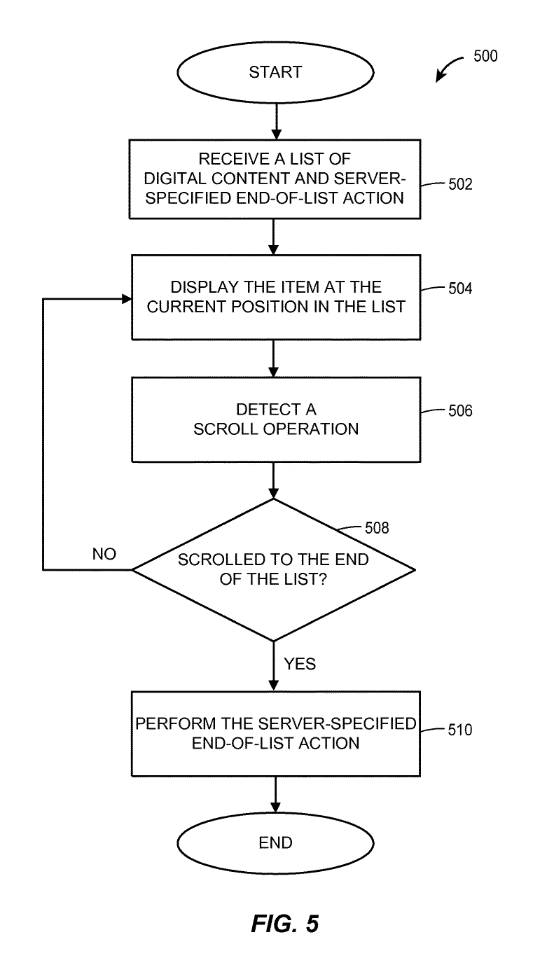

FIG. 5 is a flow diagram of an example method 500 for executing server-specified actions on a mobile device. The method 500 may be implemented in the mobile device 102, for example.

At block 502, a list of digital content is received. The list of digital content may include, for example, items with text, image, video, etc. content for display within a mapping application, such as mapping application 104. In addition to the list, a server-specified end-of-list action is received, where the server-specified action corresponds to the list of digital content and is to be executed by the mobile device upon scrolling to the end of the list, as further illustrated in FIG. 2. The server-specified action may include, for example, an action to be performed by the mapping application or an action to be performed by an application or routine that is separate from the mapping application (e.g., a web browser, calendar, social media, etc. application stored in a memory of the mobile device).

At block 504, some of the digital content within the items of the list are displayed on the mobile device (e.g., on a touchscreen device). For example, the digital content may be rendered by a GPU, such as GPU 107, and displayed within a mapping application. In one scenario, the list may include a list of text and image representations of points of interest (POIs) that match a geographic query, such as the location marker 310 and the informational card 304 illustrated in FIG. 3. The text and imagery associated with a pre-defined, or otherwise determined, number of the POIs may be displayed on a display device of the mobile device.

At block 506, an indication of a scrolling operation is received. For example, a user of the mobile device may tap, swipe, fling, or otherwise indicate a scrolling operation. In the scenario mentioned above, a user may swipe a touchscreen to scroll through the POIs that match a geographic query, for example, as further illustrated by the arrows 320 and the informational cards 304 and 330.

At block 508, it is determined if the scrolling operation, indicated at block 506, corresponds to reaching the end of the list of digital content. In the scenario mentioned above, a user may quickly swipe the touchscreen, thus scrolling the POI digital content to the end of the supplied digital content associated with matched POIs. If the scrolling operation does not correspond to reaching the end of the available digital content in the list, the flow reverts to block 504 where further digital content may be display. If, however, the scrolling operation corresponds to reaching the end of the list (e.g., the end of example list 200), the flow continues to block 510.

At block 510, the server-specified action, received at block 502, is performed. For example, the action 202 may be performed upon reaching the end of the list 200. In some scenarios, the server-specified action may include a plurality of tasks, and, in such cases, the tasks may be performed simultaneously or in series. For example, a server-specified action may include displaying an advertisement and sending a request to a server for additional content.

In an example scenario, to further illustrate the method 500, a mobile device may receive, at block 502, a list of textual informational cards corresponding to five coffee shops and a corresponding end-of-list action, as a result of a geographic query for coffee shops. Then, at block 504, at least some of the informational cards may be displayed on the mobile device. At blocks 506 and 508, the mobile device may detect that a user of the mobile device is scrolling through the informational cards about the five coffee shops and reaching an end of the list of informational cards (e.g., the last of the five coffee shops in the itemized and/or ordered list). Upon detecting the reaching of the end of the list, the mobile device may execute the corresponding action at block 510, which, in this scenario, may include retrieving further textual informational cards about different coffee shops.

### Generating Server-Specified Actions

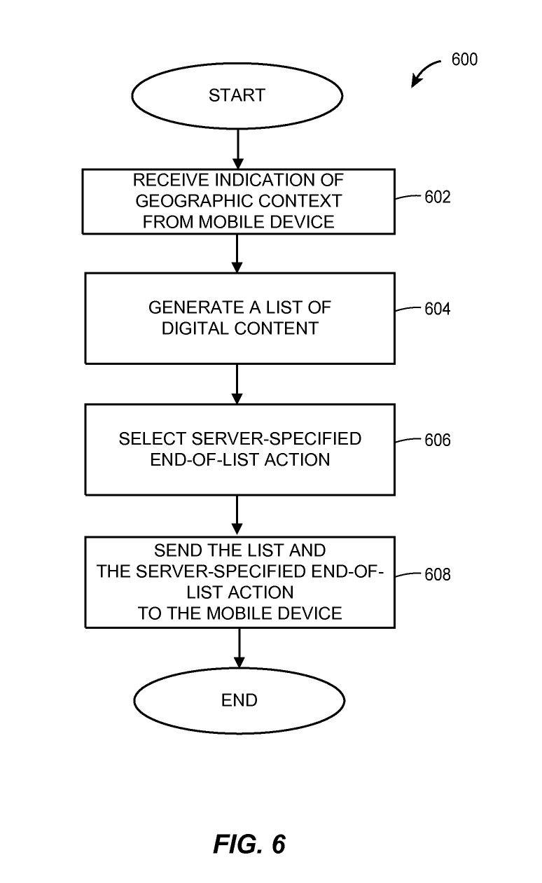

FIG. 6 is a flow diagram of an example method 600 for generating itemized lists with corresponding server-specified actions. The method 600 may be implemented in the map data server 108, for example.

At block 602, a specific (e.g., specific to a mobile device) geographic context is received. The geographic context may include a geographic query, indication of a current map viewport, indication of a zoom level, one or more geographic locations, navigation query, etc. In some scenarios, a mobile device may send a request including a geographic context to a server, such as the map data server 108, in response to user interaction with the mobile device. In other scenarios, a mobile device may automatically send indications of geographic context to a server and/or a server may automatically infer a geographic context based on previous data sent to the mobile device or data indicative of a history of user interaction, assuming a user consents to such use of the data.

At block 604, a list of digital content, such as one of the lists illustrated in FIG. 2, is generated in response to receiving the geographic context. The type and/or number of items within the list may be determined based on the type and content of the geographic context, in some implementations. For example, a server may generate items in a list of digital content based on a navigation query where each item in the list includes content, such as text directions, images of roads, audio alerts, etc., corresponding to each respective step of a navigation route. Alternatively, the digital content in a list of digital content may be distributed into individual items such that each item in the list contains data of a similar size, in an implementation.

At block 606, a server-specified action is generated, such as one of the example actions 202 or 212. The server-specified action corresponds to the list of digital content and is to be performed upon scrolling to the end of the list. For example, a server may generate the action based on the geographic context, types or similarities of digital content in the list, size of the list, rules stored in a database, user profile (assuming a user consents to such use of the profile), etc. In one scenario, a server may determine that a particular type of advertisement is to be displayed upon scrolling to the end of the list based on the type of content in the list (e.g., pizza restaurants) and/or a user profile (e.g., interaction history, physical location, etc.). For example, an action corresponding to the end of a list indicating pizza restaurants may include displaying an advertisement for a certain pizza restaurant or displaying an advertisement for a pizza restaurant close to the home of a user (as indicated in a user profile). In another scenario, a server may determine that a browser window should be opened based on a rule for a particular type or format of geographic context.

At block 608, the list of digital content and the server-specified action, such as the example list 200 and the example action 202, are sent to the mobile device. In some implementations, a POST request, as supported by the Hypertext Transfer Protocol (HTTP), may be used to send each item to a mobile device over a network, such as network 112 which may include any suitable mobile and/or wide area network, such as the internet. In some implementations, an application protocol associated with a particular type of software application, such as a protocol for mapping applications, is used on top of or in place of HTTP. Also, digital content corresponding to multiple items and/or portions of individual items may be sent using a single HTTP, or other suitable, request, in an implementation.

In an example scenario, to further illustrate the method 600, a geographic query for coffee shops may be received at block 602. Subsequently, at block 604, a list of five textual informational cards about a corresponding five coffee shops may be generated for display on the requesting device. An end-of-list action is also selected, at block 606, for execution by the requesting device upon reaching (e.g., via scrolling) the end of the five informational cards (e.g., the fifth informational card). The end-of-list action may include requesting further textual informational cards about different coffee shops, for example. At block 608, the list of five informational cards and the corresponding end-of-list action is sent to the requesting mobile device.

### Additional Considerations

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain embodiments are described herein as including logic or a number of components or modules. Modules may constitute either software modules (e.g., code stored on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

A hardware module may be implemented electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module in dedicated and permanently configured circuitry, or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware and software modules can provide information to, and receive information from, other hardware and/or software modules. Accordingly, the described hardware modules may be regarded as being communicatively coupled. Where multiple of such hardware or software modules exist contemporaneously, communications may be achieved through signal transmission (e.g., over appropriate circuits and buses) that connect the hardware or software modules. In embodiments in which multiple hardware modules or software are configured or instantiated at different times, communications between such hardware or software modules may be achieved, for example, through the storage and retrieval of information in memory structures to which the multiple hardware or software modules have access. For example, one hardware or software module may perform an operation and store the output of that operation in a memory device to which it is communicatively coupled. A further hardware or software module may then, at a later time, access the memory device to retrieve and process the stored output. Hardware and software modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as an SaaS. For example, as indicated above, at least some of the operations may be performed by a group of computers (as examples of machines including processors), these operations being accessible via a network (e.g., the Internet) and via one or more appropriate interfaces (e.g., APIs).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations (e.g., across any suitable number of data centers).

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” or a “routine” is a self- consistent sequence of operations or similar processing leading to a desired result. In this context, algorithms, routines and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Upon reading this disclosure, those of skill in the art will appreciate still additional alternative structural and functional designs for providing item with server-specified end-of-list actions in a mapping application through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A method implemented in a client device for providing geographic content via a user interface of the client device, the method comprising:
generating, by one or more processors, a description of a geographic context of the client device;
providing, by the one or more processors, the description of the geographic context to a network server;
receiving, from the network server, in response to the provided description of the geographic context:
(i) an ordered list of items, each item including respective geographic data selected at the network server in accordance with the geographic context, and
(ii) an indication of an action to be automatically executed by a software application at the client device when a user reaches an end of the ordered list of items via the user interface;
presenting, by the software application, the ordered list of items to be presented to a user via the user interface of the client device; and
in response to an indication that the end of the ordered list of items is reached by the user, automatically executing, by the software application, the indicated action.

2. The method of claim 1, wherein the action to be executed at the client device when the user reaches the end of the ordered list of items includes presenting an advertisement to the user via the user interface.

3. The method of claim 1, wherein the action to be executed at the client device when the user reaches the end of the ordered list of items includes opening, on the user interface, at least one of a web browser, email, text messaging, or phone call application.

4. The method of claim 1, wherein the action to be executed at the client device when the user reaches the end of the ordered list of items includes requesting, by the one or more processors from the network server, at least one of an additional list of items or additional map data for displaying a digital map.

5. The method of claim 1, further comprising receiving an indication that the user reaches the end of the ordered list of items in response to the user scrolling through the list of items on the user interface.

6. The method of claim 1, wherein generating the description of the geographic context includes generating a geographic query.

7. The method of claim 1, wherein generating the description of the geographic context includes generating an indication of at least one of a current map viewport or a zoom level.

8. The method of claim 1, wherein the action to be executed at the client device, when the user reaches the end of the ordered list of items, includes a plurality of different tasks to be performed by the client device, each task corresponding to a different function of an application executed by the client device.

9. The method of claim 8, further comprising, in response to the indication that the end of the ordered list of items is reached by the user, executing, by the one or more processors, each of the plurality of tasks in the action.

10. The method of claim 1, wherein generating the description of the geographic context includes one of:
(i) generating an indication of one or more geographic locations corresponding to a current location of the client device, or
(ii) generating an indication of a user-specified location received via a user interface of the client device.

11. The method of claim 1, wherein the respective geographic data in each item includes at least two or more of a passage of text, an image, a video, an audio clip, or a hyperlink related to the geographic context.

12. A method in a network server for generating and communicating server-specified actions to client devices, the method comprising:
receiving a description of a geographic context of a client device;
in response to receiving the description of the geographic context, generating, by one or more processors, an ordered list of selectable items, each selectable item in the ordered list including interactive digital content selected based on the description of the geographic context;
selecting, by the one or more processors, an action to be automatically executed by a software application on the client device when a user of the client device reaches an end of the ordered list of selectable items; and
providing, by the one or more processors, the ordered list of selectable items and an indication of the action to the client device.

13. The method of claim 12, wherein receiving a description of the geographic context includes automatically inferring the geographic context based on at least one of:
(i) a history of data previously sent from the network server to the client device, or
(ii) a history of user interaction with the client device.

14. The method of claim 13, further comprising analyzing, by the one or more processors, the at least one of the history of data previously sent from the network server to the client device or the history of user interaction with the client device to generate the geographic context corresponding to the client device.

15. The method of claim 12, wherein selecting the action includes selecting the action based on similarities of points of interest, the points of interest corresponding to the interactive digital content included in the ordered list of selectable items.

16. The method of claim 12, wherein selecting the action includes selecting the action based on a user profile corresponding to the user of the client device.

17. A system comprising:
one or more processors; and
a non-transitory computer-readable medium storing thereon instructions that, when executed by the one or more processors, cause the system to:
receive a description of a geographic context of a client device,
in response to receiving the description of the geographic context, generate an ordered list of items, each item in the ordered list including interactive digital content selected based on the description of the geographic context,
select an action to be automatically executed by a software application on the client device when a user of the client device reaches an end of the ordered list of items, and
provide the ordered list of items and an indication of the action to the client device.

18. The system of claim 17, wherein the interactive digital content includes at least two or more of a passage of text, an image, a video, an audio clip, or a hyperlink.

19. The system of claim 18, wherein receiving a description of the geographic context includes automatically inferring the geographic context based on at least one of:
(i) a history of data previously sent from the network server to the client device, or
(ii) a history of user interaction with the client device.

20. The system of claim 19, wherein the instruction further cause the system to analyze the at least one of the history of data previously sent from the network server to the client device or the history of user interaction with the client device to generate the geographic context corresponding to the client device.
